(19) United States
(12) Patent Application Publication
(10) Pub. No.: US 2020/0371372 A1
(43) Pub. Date: Nov. 26, 2020

(54) OPTICAL COMPONENT, OPTICAL DEVICE, AND ELECTRONIC DEVICE USING SAME

(71) Applicants: Interface Technology (ChengDu) Co., Ltd., Chengdu (CN); INTERFACE OPTOELECTRONICS (SHENZHEN) CO., LTD., Shenzhen (CN); GENERAL INTERFACE SOLUTION LIMITED, Zhunan (TW)

(72) Inventors: PO-JUNG HUNAG, Hsinchu (TW); CHING-HAO LIAO, Hsinchu (TW)

(21) Appl. No.: 16/527,148

(22) Filed: Jul. 31, 2019

(30) Foreign Application Priority Data
May 24, 2019 (CN) 201910439440.X

(51) Int. Cl. G02B 27/42; G02B 27/30; G02B 7/00

(52) U.S. Cl. CPC G02B 27/425; G02B 7/00; G02B 27/30

(57) ABSTRACT

An optical component includes a housing. The housing defines a receiving cavity and includes a bottom plate and a side plate connecting a peripheral portion of the bottom plate. The optical component further includes a collimating component and a diffractive optical element (DOE) in the receiving cavity. The collimating component is configured for collimating the light into collimated light. The DOE includes a diffractive portion configured for converting the collimated light into structured light and a bezel surrounding the diffractive portion. The optical component further includes a first adhesive layer and a second adhesive layer. The first adhesive layer is between the bezel and the collimating component and contacts the side plate. The second adhesive layer filling a silt between the side plate and the collimating component.

### FIELD

The subject matter herein generally relates to a field of optical imaging, particularly relates to an optical component, an optical device and an electronic device using the optical component.

### BACKGROUND

A principle of a structured light emitting device is that light emitted from a light source can be collimated by a collimating element and then irradiated onto a diffractive optical element (DOE), then light is diffracted by the DOE to form a structured light having a predetermined pattern, and the structured light is projected onto a surface of a target object. As shown in FIG. 1, a DOE 15 generally includes a diffracting portion 15a and a bezel portion 15b surrounding the diffracting portion 15a. The bezel portion 15b is provided with conductive pins (not shown). In light diffraction, the diffracting portion 15a in the DOE 15 is for diffracting incident light and outputting structured light having a predetermined pattern.

The structured light emitting device includes a light source and a structured light emitting component. An assembly process of the structured light emitting component is shown in FIG. 1. A collimating component 14 is bonded to the bezel portion 15b of the DOE 15 by a first adhesive layer 16. Conductive adhesive 18 is disposed at an edge of a bottom wall 11a of a housing 11, and the collimating component 14 bonded to the DOE 15 are positioned into the housing 11, and the bezel portion 15b is bonded to the housing 11 by the conductive adhesive 18. A slit between the collimating component 14 and the housing 11 is filled with adhesive to form a second adhesive layer 17. However, the adhesive can easily overflow to the surface of the bottom wall 11a of the housing 11 facing the diffracting portion 15a, which renders the pattern of the structured light inconsistent, thereby affecting the imaging quality of the depth camera.

Therefore, there is room for improvement in the art.

### BRIEF DESCRIPTION OF THE DRAWINGS

Implementations of the present technology will now be described, by way of embodiment, with reference to the attached figures.

FIG. 1 shows an assembly process of a structured light emitting component in the prior art.

FIG. 2 is a block diagram of an electronic device.

FIG. 3 is a cross-sectional view of an optical device in FIG. 2.

FIG. 4A, FIG. 4B, FIG. 4C, and FIG. 4D are cross-sectional views showing stages of an assembly process of the structured light emitting component.

FIG. 5A, FIG. 5B, FIG. 5C, FIG. 5D, and FIG. 5E are bottom views showing stages of the assembly process of the structured light emitting component.

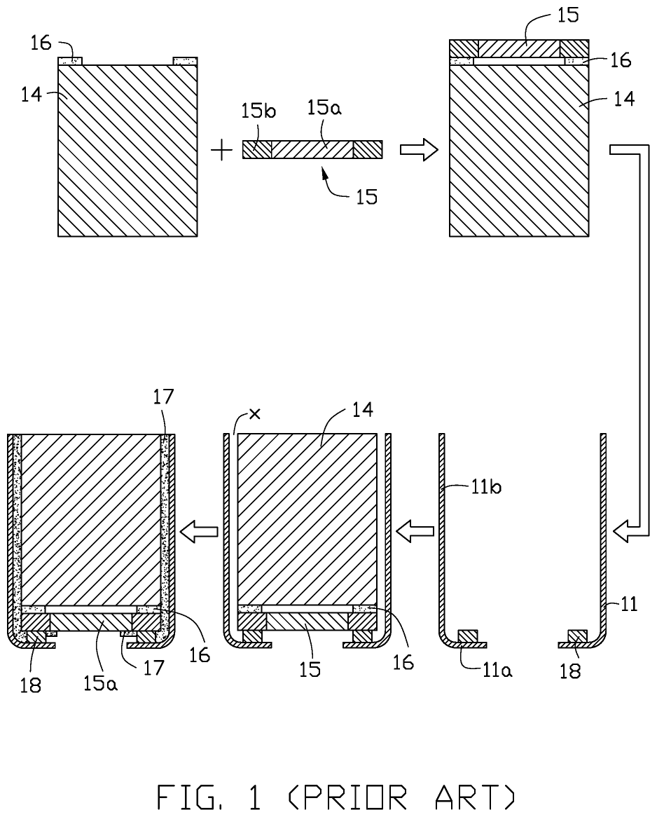

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as coupled, whether directly or indirectly through intervening components, and is not necessarily limited to physical connections. The connection can be such that the objects are permanently coupled or releasably coupled. The term “comprising” when utilized, means “including, but not necessarily limited to”; it specifically indicates open-ended inclusion or membership in the so-described combination, group, series, and the like.

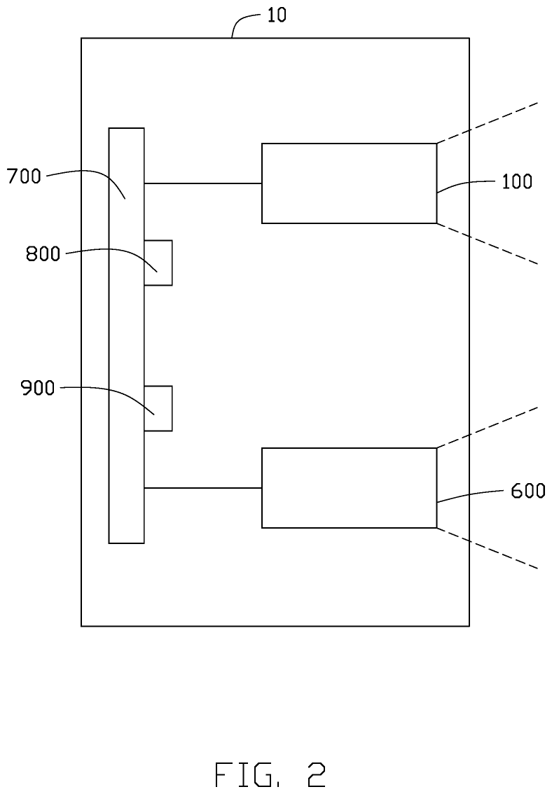

Referring to FIG. 2, an electronic device 10 includes an optical device 100, an image acquisition device 600, a circuit board 700, a controller 800, and an image processor 900. Both the image processor 900 and the controller 800 are located on the circuit board 700; and both the optical device 100 and the image acquisition device 600 are communicated with the circuit board 700.

The controller 800 is configured to control the optical device 100 to emit structured light having a preset pattern onto a target. The image acquisition device 600 acquires images formed as the structured light pattern is projected onto the target. The image processor 900 compares the structured light pattern with the structured light images to obtain a difference value of each pixel point, and calculates to obtain a depth image of the target according to the difference values. In one embodiment, the controller 800 may adjust and control the structured light emitted from the optical device 100 in accordance with a quality of the depth image.

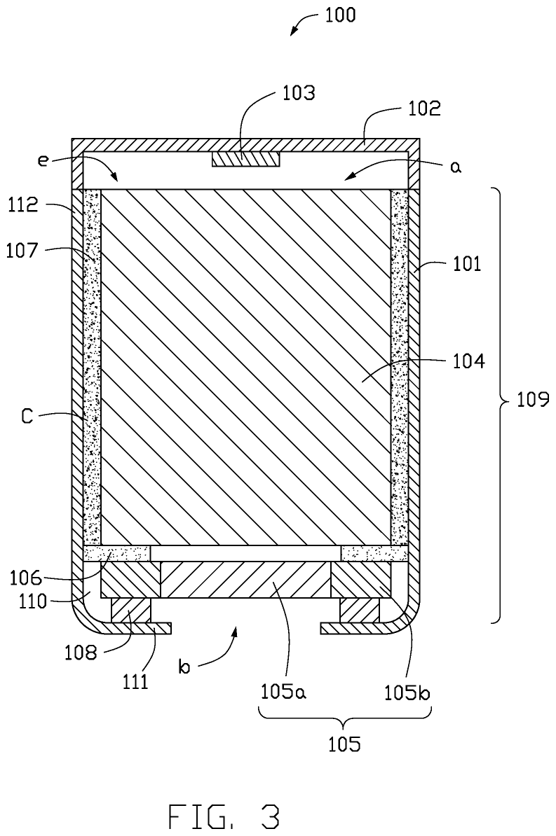

Referring to FIG. 3, the optical device 100 includes a substrate 102, a light source 103, and an optical component 109. The optical component 109 includes a housing 101, a collimating component 104, a DOE 105, a first adhesive layer 106, and a second adhesive layer 107.

The housing 101 is hollow and defines a receiving cavity 110. The housing 101 includes a bottom plate 111 and a side plate 112 connecting to a peripheral portion of the bottom plate 111. The bottom plate 111 defines a light exit b to allow light to pass through. An end of the side plate 112 away from the bottom plate 111 forms a first opening a. Both the first opening a and the light exit b air communicate with the receiving cavity 110. The collimating component 104, the DOE 105, the first adhesive layer 106, and the second adhesive layer 107 are positioned in the receiving cavity 110 by the first opening a.

The substrate 102 is positioned above and covers the first opening a. The light source 103 is fixed on the substrate 102 and received in a receiving space e formed by the substrate 102. The collimating component 104 and the DOE 105 are positioned in the housing 101, wherein the collimating component 104 is adjacent to the light source 103. The light source 103 is configured for emitting light to the collimating element 104; the collimating element 104 is configured for collimating the light into collimated light; and the DOE 105 is configured for converting the collimated light into structured light. The first adhesive layer 106 is connected between the collimating element 104 and the DOE 105 and extends to contact the side plate 112. The second adhesive layer 107 fills a slit c between the side plate 112 and the collimating component 104, and the slit c is filled with the first adhesive layer 106.

In the present embodiment, the housing 101 is made of an opaque metal which can block light, and the light emitted from the light source 103 inside the housing 101 cannot pass through the plate of the housing 101. The housing 101 is made of a metal for electrically connecting the DOE 105 and is conductive. In one embodiment, the bottom plate 111 is provided with conductive portion for conducting electrical signals.

In one embodiment, the light source 103 includes an edge-emitting laser diode. In another embodiment, the light source 103 includes a vertical-cavity surface-emitting laser (VCSEL) diode array. The VCSEL diodes used as the light source 103 simultaneously perform light emitting and patterning. The VCSEL diodes can generate narrow and high density beams of light. In one embodiment, the semiconductor diodes of the light source 103 can be sequentially illuminated, thereby achieving power consumption reduction, decoding rate enhancement, and/or performance improvement. Shapes and sizes of the semiconductor diodes of the light source 103 may be different from each other.

The collimating component 104 receives light from the light source 103 and confines a cross-section of the light, thereby forming collimated light. In one embodiment, the collimating component 104 may comprise a collimating lens. The collimating lens is made of a transparent material (such as plastic or glass) and can be fabricated using wafer level optical (WLO) technology. In one embodiment, the collimating lens is a plano-convex lens that is planar on a side facing the light source 103 and convex on the other side. The collimating component 104 can be a single lens, although multiple lenses or a set of lenses can also be used to construct the collimating component 104.

The DOE 105 includes a diffractive portion 105a and a bezel 105b. The diffractive portion 105a is located in a geometrically central region of the DOE 105 and receives the collimated light. The diffractive portion 105a converts the collimated light into structured light conforming to a predetermined pattern. The bezel 105b surrounds the diffractive portion 105a. The bezel 105b may be made of a metal material to conduct electrical signals. In other embodiment, the bezel 105b is made of a non-metallic material, and the DOE 105 includes a first conductive portion on the bezel 105b for transmitting electrical signals.

The first adhesive layer 106 is between the collimating component 104 and the bezel 105b, thus the collimating component 104 and the DOE 105 are bonded together. The first adhesive layer 106 extends to contact the side plate 112. The second adhesive layer 107 infills the slit c between the collimating component 104 and the first adhesive layer 106. The first adhesive layer 106 blocks the second adhesive layer 107 from contacting the DOE 105, especially from contacting the diffractive portion 105a of the DOE 105. Thus, the adhesive in the second adhesive layer 107 does not overflow onto the diffractive portion 105a of the DOE 105, which facilitates a pattern of the structured light exiting from the DOE 105 to conform to a preset pattern, thereby ensuring the image quality of the depth image.

In the present embodiment, the first adhesive layer 106 extends on the side plate 112 and surrounds the diffractive portion 105a, thereby preventing the adhesive in the second adhesive layer 107 from overflowing to the diffractive portion 105a. In one embodiment, the first adhesive layer 106 includes a plurality of segments on the bezel 105b such that a portion of the slit c is blocked by the first adhesive layer 106. Other portions of the slit c are blocked by other elements, such that the slit c does not extend to a surface of the diffractive portion 105a, thereby ensuring that the adhesive in the second adhesive layer 107 cannot overflow onto the diffractive portion 105a.

The first adhesive layer 106 is configured to block the second adhesive layer 107 from contacting the diffractive portion 105a. The first adhesive layer 106 includes a first adhesive. The first adhesive is for bonding the collimating component 104, the bezel 105b, and the side plate 112. In one embodiment, the first adhesive includes a photosensitive adhesive, and can be pre-cured by ultraviolet light. The second adhesive layer 107 includes a second adhesive, and the second adhesive can be reinforcing glue. The viscosity of the first adhesive is higher than a viscosity of the second adhesive. That is, a fluidity of the first adhesive is less than a fluidity of the second adhesive in order to reduce curing time of the first adhesive.

The optical component 109 further includes a conductive adhesive 108 for bonding the bezel 105b to a inner wall of the bottom plate 111; or bonding a first electrical conductor (such as a metal connection pad) on a side of the DOE 105 away from the collimating component 104 to the inner wall of the bottom plate 111. Alternatively, the adhesive 108 can bond the bezel 105b to a second electrical conductor (such as a metal connection pad) on the bottom plate 111. The conductive adhesive 108 may be a conductive silver paste.

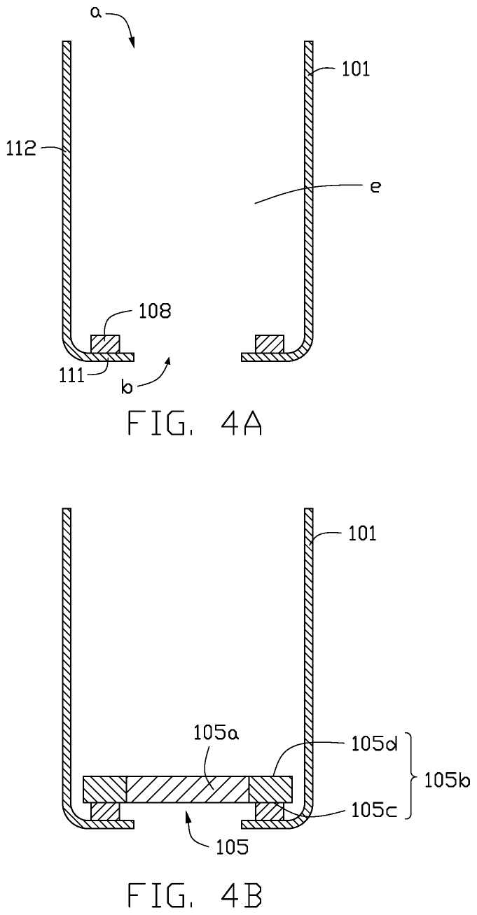

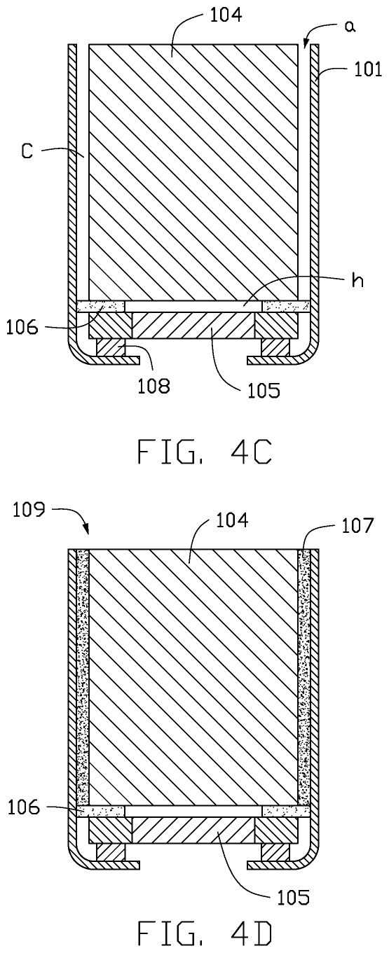

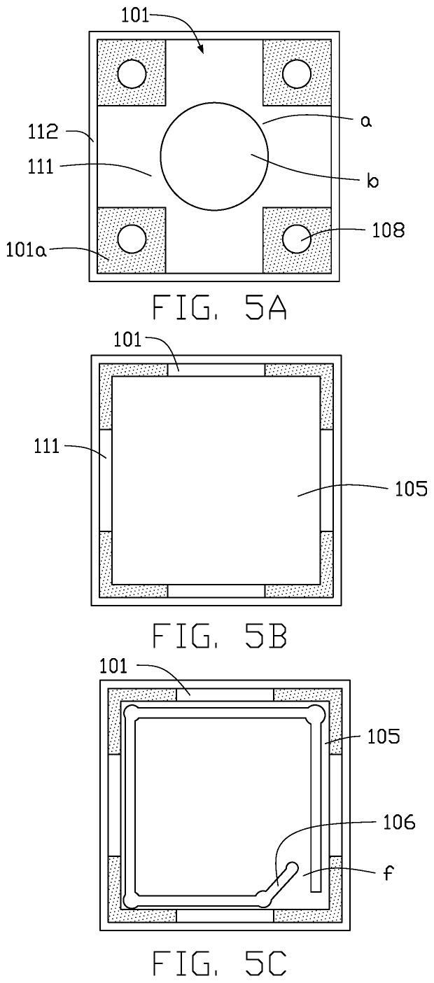

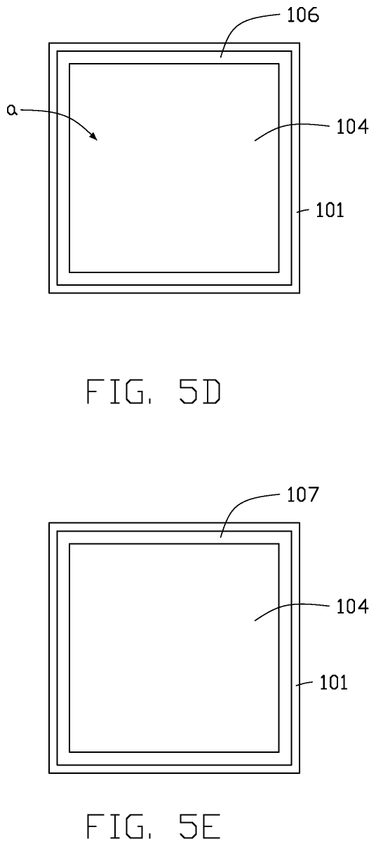

FIG. 4A through FIG. 4D and FIG. 5A through FIG. 5E illustrate a method of assembling the optical component 109. The method includes the following steps.

S1: a housing 101 is provided, and a conductive adhesive 108 is formed on the housing 101.

As shown in FIG. 4A and FIG. 5A, the housing 101 includes a bottom plate 111 and a side plate 112 connecting a peripheral portion of the bottom plate 111. An end of the side plate 112 away from the bottom plate 111 forms a first opening a, the bottom plate 111 defines a light exit b. Second conductive portions 101a, shown in FIG. 5A, are provided on an inner surface of the bottom plate 111. The bottom plate 111 has a square shape, and four second conductive portions 101a are each positioned in the corner of the bottom plate 111. The conductive adhesive 108 is formed on each second conductive portion 101a, and the conductive adhesive 108 may be a conductive silver paste.

S2: a DOE 105 is formed on the housing 101 and bonded to the housing 101 by the conductive adhesive 108.

As shown in FIG. 4B and FIG. 5B, the DOE 105 includes a diffractive portion 105a and a bezel 105b surrounding the diffractive portion 105a. The diffractive portion 105a is configured for diffracting light. The bezel 105b may be made of a metal material to conduct electrical signals. In other embodiment, the bezel 105b is made of a non-metallic material, and the DOE 105 includes a first conductive portion on the bezel 105b for transmitting electrical signals. The bezel 105b is bonded to an inner surface of the bottom plate 111 by the conductive adhesive 108. The bezel 105b has a first surface 105c and a second surface 105d opposite to the first surface 105c, the first surface 105c is in direct contact with the conductive adhesive 108.

S3: a first adhesive is applied on the second surface 105d to form a first adhesive layer 106.

As shown in FIG. 5C, the second surface 105d is a surface of the bezel 105b away from the conductive adhesive 108. The second surface 105d positions other elements thereon. The first adhesive is a photosensitive adhesive having a high viscosity and can be pre-cured by ultraviolet light.

A shape and a size of the first adhesive applied on the second surface 105d is controlled such that when the collimating component 104 is bonded to a side of the first adhesive layer 106 facing away from the DOE 105, the first adhesive can overflow from a region between the bezel 105b and the collimating component 104 and contact the side plate 112. A projection of the first adhesive layer 106 on the bottom plate 111 has a square shape and an opening f.

S4: a collimating component 104 is bonded on the first adhesive layer 106.

As shown in FIG. 4C and FIG. 5D, the collimating component 104 is applied to a side of the first adhesive layer 106 away from the DOE 105, and the first adhesive in the first adhesive layer 106 flows to contact the side plate 112.

A pattern recognition method may be used to determine whether the first adhesive has contacted the side plate 112. If not, the collimating component 104 needs to be pushed in a direction toward the DOE 105 to squeeze the first adhesive, thereby forcing the first adhesive to escape from a region between the bezel 105b and the collimating component 104. Pattern recognition is a kind of image recognition to automatically complete the process of identification and evaluation.

S5: the first adhesive is cured to form the solid adhesive layer 106.

In one embodiment, the first adhesive is photosensitive adhesive, and can be pre-cured by ultraviolet light, being entirely cured by baking. As shown in FIG. 4C, the collimating component 104, the DOE 105, and the adhesive layer 106 cooperatively form a receiving space h. When baking the first adhesive, gas in the receiving space h may expand and escape from the opening f (FIG. 5C), thereby preventing the gas from destroying the components and connection between components.

In other embodiments, the first adhesive may also adopt other types of adhesives and accordingly the curing manner is different.

After step S4 is completed, a first semi-finished product is obtained. Specifically, the first semi-finished product includes the housing 101, the conductive adhesive 108, the DOE 105, the first adhesive layer 106, and a collimating component 104. Since the first adhesive has low fluidity, the first semi-finished product can be left for a period of time, and the other first semi-finished products can be assembled according to steps S1-S4. After assembling first semi-finished products, step S5 can be performed on the first semi-finished products at the same time, which effectively reduces processing time and is advantageous for improving efficiency. The first semi-finished product after step S5 is a second semi-finished product.

S6: a second adhesive is applied between the side plate and the collimating component 104.

As shown in FIG. 4D and FIG. 5E, the second adhesive layer 107 fills a slit c between the side plate 101 and the collimating component 104. As the first adhesive is cured, the second adhesive cannot overflow onto the diffractive portion 105a. In this embodiment, a viscosity of the second adhesive is less than a viscosity of the first adhesive, allowing the slit c to be easily filled with the second adhesive.

S7: the second adhesive is cured.

The second adhesive can be cured by heating.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. An optical component comprising:
a housing, the housing defining a receiving cavity, the housing comprising a bottom plate and a side plate connecting a peripheral portion of the bottom plate, the bottom plate defining a light exit air communicating with the receiving cavity;
a collimating component in the receiving cavity and configured for collimating light into collimated light;
a diffractive optical element (DOE) in the receiving cavity, the DOE comprising:
a diffractive portion configured for converting the collimated light into structured light; and
a bezel surrounding the diffractive portion;
a first adhesive layer, the first adhesive layer being between the bezel and the collimating component, the first adhesive layer contacting the side plate; and
a second adhesive layer, the second adhesive layer filling a silt between the side plate and the collimating component.

2. The optical component of claim 1, wherein the first adhesive layer extends to surrounds the diffractive portion; the first adhesive layer is configured to block the second adhesive layer from contacting the DOE.

3. The optical component of claim 1, wherein the first adhesive layer comprises photosensitive adhesive.

4. The optical component of claim 1, wherein the bezel is made of a metal material to conduct electrical signals.

5. The optical component of claim 1, wherein the bezel is made of a non-metallic material, and the DOE comprises a first conductive portion on the bezel for conducting electrical signals.

6. An optical device, comprising:
an optical component, the optical component comprising:
a housing, the housing defining a receiving cavity, the housing comprising a bottom plate and a side plate connecting a peripheral portion of the bottom plate, the bottom plate defining a light exit air communicating with the receiving cavity;
a collimating component in the receiving cavity and configured for collimating light into collimated light;
a diffractive optical element (DOE) in the receiving cavity, the DOE comprising:
a diffractive portion configured for converting the collimated light into structured light; and
a bezel surrounding the diffractive portion;
a first adhesive layer, the first adhesive layer being between the bezel and the collimating component, the first adhesive layer contacting the side plate; and
a second adhesive layer, the second adhesive layer filling a silt between the side plate and the collimating component; and
a light source emitting light to the collimating component.

7. The optical device of claim 6, wherein the first adhesive layer extends to surrounds the diffractive portion; the first adhesive layer is configured to block the second adhesive layer from contacting the DOE.

8. The optical device of claim 6, wherein the first adhesive layer comprises photosensitive adhesive.

9. The optical device of claim 6, wherein the bezel is made of a metal material to conduct electrical signals.

10. The optical device of claim 6, wherein the bezel is made of a non-metallic material, and the DOE comprises a first conductive portion on the bezel for conducting electrical signals.

11. An electronic device, comprising:
an optical device, the optical device comprising:
an optical component, the optical component comprising:
a housing, the housing defining a receiving cavity, the housing comprising a bottom plate and a side plate connecting a peripheral portion of the bottom plate, the bottom plate defining a light exit air communicating with the receiving cavity;
a collimating component in the receiving cavity and configured for collimating light into collimated light;
a diffractive optical element (DOE) in the receiving cavity, the DOE comprising:
a diffractive portion configured for converting the collimated light into structured light; and
a bezel surrounding the diffractive portion;
a first adhesive layer, the first adhesive layer being between the bezel and the collimating component, the first adhesive layer contacting the side plate; and
a second adhesive layer, the second adhesive layer filling a silt between the side plate and the collimating component; and
a light source emitting light to the collimating component;
an image acquisition device configured to acquire structured light images formed after the structured light is projected onto a spatial target; and
an image processor configured to calculate to obtain a depth image of the spatial target according to the structured light images.

12. The electronic device of claim 11, wherein the first adhesive layer extends to surrounds the diffractive portion; the first adhesive layer is configured to block the second adhesive layer from contacting the DOE.

13. The electronic device of claim 11, wherein the first adhesive layer comprises photosensitive adhesive.

14. The electronic device of claim 11, wherein the bezel is made of a metal material to conduct electrical signals.

15. The electronic device of claim 11, wherein the bezel is made of a non-metallic material, and the DOE comprises a first conductive portion on the bezel for conducting electrical signals.
